(19) United States
(12) Patent Application Publication
(10) Pub. No.: US 2005/0096985 A1
(43) Pub. Date: May 5, 2005

(54) Business system and method for a virtual point of sale system in a retail store

(76) Inventor: Todd C. Werden, Sandy Hook, CT (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/699,871

(22) Filed: Nov. 4, 2003

(51) Int. Cl. G06F 17/60

(52) U.S. Cl. 705/16; 705/26

(57) ABSTRACT

A system and method allow store personnel to perform most checkout and automated payment (e.g., credit and debit cards) at any location in the store. One or more projectors, cameras and activation devices, are connected to the store network through wires or by wireless. The sales person would signify that a customer is ready to check out by using a small device, like a clicker or push button carried on their person. A projector and a camera, networked to the existing store Point-of-Sale (POS) system, locates the sales person and then, using certain algorithms, locates a blank space (on a wall or a table, for example) and displays the standard Point-of-Sale (POS) application. The camera monitors movements and allows the sales person to use the application interactively in the same manner as if he or she were at the actual check out counter using a computer terminal.

### BACKGROUND OF THE INVENTION

1. Field of the Invention

The present invention generally relates to the Point-of-Sale (POS) systems for retail stores and, more particularly, to a virtual POS system and method for retail stores which allow store personnel to perform most checkout and automated payment at any location of the store.

2. Background Description

All retail stores have the need to sell merchandise to customers and collect payment. Many retailers have systems that provide additional functions, such as returns, price look up, layaway, inventory control, and so on. Additionally, there exist a set of requirements to perform what are commonly known as “back office” operations. These may include price management, employee scheduling, time clock, promotion management, e-mail and other support operations.

Most stores also interact with the outside world, particularly for credit authorization, whereby (either by dial-up telephone line or dedicated network circuit) a store will contact a credit processor for approval when a customer wishes to pay using a credit or debit card.

There are many different types of retail organizations, some big, some small, with many different types of merchandise and customers, but with respect to POS they all have on thing in common—there is a place (or a number of places) within the establishment where physical computer equipment of some sort is used by employees to service customers. Sometimes there is one central check out desk with multiple computers, sometimes check out desks are located throughout the store (e.g., Department stores) and in some stores (Supermarkets, for example) there may be several similar check out stations in a group.

Many retailers have Loyalty or Frequent Shopper programs, whereby a customer has a method of identifying themselves to the retailer at point of sale, and the retailer maintains points for the customer, gives a discount or provides some other special incentive.

Although the computer software (and, to some degree, the computer hardware) is usually customized to meet the retailer's specific needs, most of the standard sale transactions are very similar. In essence, the customer brings their selected merchandise to the check out counter, where the employee activates the computer software used to conduct a sale and identifies themselves to the computer system, usually with a password and ID. The employee will then enter the merchandise to be purchased (either through keyboard entry or scanning of a product bar code). Often, the computer system has the appropriate prices stored and will retrieve them for each product. In some instances, the employee will remove security tags or deactivate embedded security devices on the product packaging. Next, the customer will provide a method of payment (cash, check, credit and debit cards are the most frequent). Depending on the mode of payment the employee will perform the necessary validation, give change (if appropriate) and produce a receipt.

Current best practices for customer check out in retail store locations all require that the customer bring purchased items to a check out location for processing and payment.

### SUMMARY OF THE INVENTION

It is therefore an object of the present invention to provide a system and method that allow store personnel to perform most checkout and automated payment (e.g., credit and debit cards) at any location in or around the store, including outside the store (e.g., plant nurseries).

According to the invention, one or more projectors, cameras and activation devices, are connected to the store network through wires or by wireless. The sales person would signify that a customer is ready to check out by using a small device, like a clicker or push button carried on their person. A projector and a camera, networked to the existing store Point-of-Sale (POS) system, locates the sales person and then, using certain algorithms, locates a blank space (on a wall or a table, for example) and displays the standard Point-of-Sale (POS) application. The camera monitors movements and allows the sales person to use the application interactively in the same manner as if he or she were at the actual check out counter using a computer terminal.

Thus, the full functionality of the Point-of-Sale (POS) store application is available, including entry for access, sales, returns and so on, mimicking a touch screen application. The activation device held by the sales associate is used to scan product bar codes. A small magnetic strip reader, combined with a printer, enables the reading of a credit/debit card and the printing of the customer receipt. Additionally, if the customer desires to pay cash, the transaction could be saved and then accessed at the traditional check out counter for tendering of payment.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the system according to a preferred embodiment of the invention;

FIGS. 2A and 2B are respectively three quarter front and rear pictorial views of an integrated activation device, scanner, magnetic stripe reader and printer carried by a sales associate; and

FIG. 3 is a flow diagram illustrating the logic of the process implemented on the system of FIG. 1.

### DETAILED DESCRIPTION OF A PREFERRED EMBODIMENT OF THE INVENTION

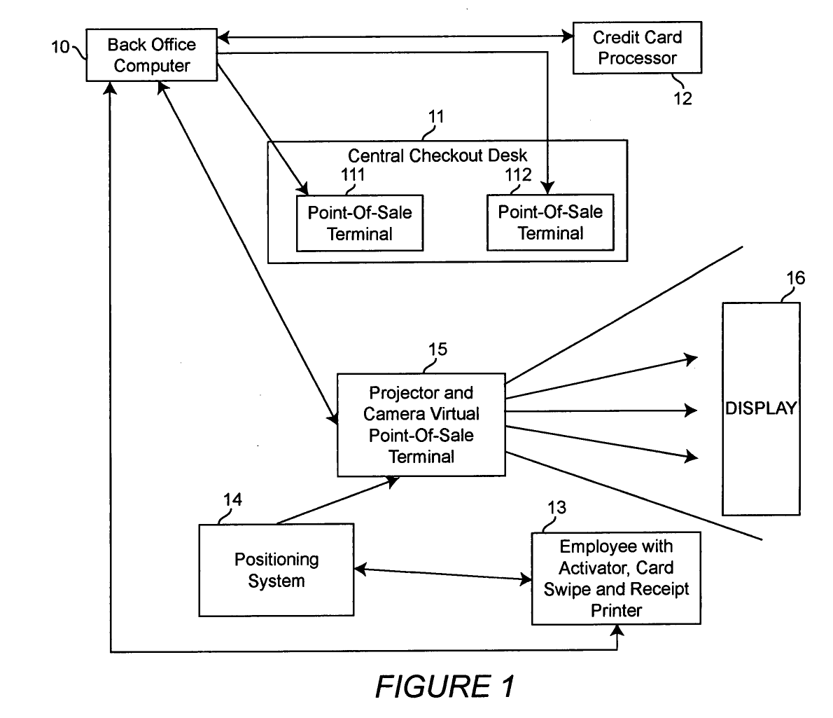

Referring now to the drawings, and more particularly to FIG. 1, there is shown a block diagram of the system according to a preferred embodiment of the invention. The retail store has an installed computer network which comprises a back office computer 10, or server, with installed back office application software for accounting, inventory control and the like. The back office computer 10 connects to one or more Point-of-Sale terminals 111 and 112 at a central checkout desk or desks 11. The back office computer 10 also connects to a credit card processor 12, which in turn may connect to an outside bank or credit institution (not shown).

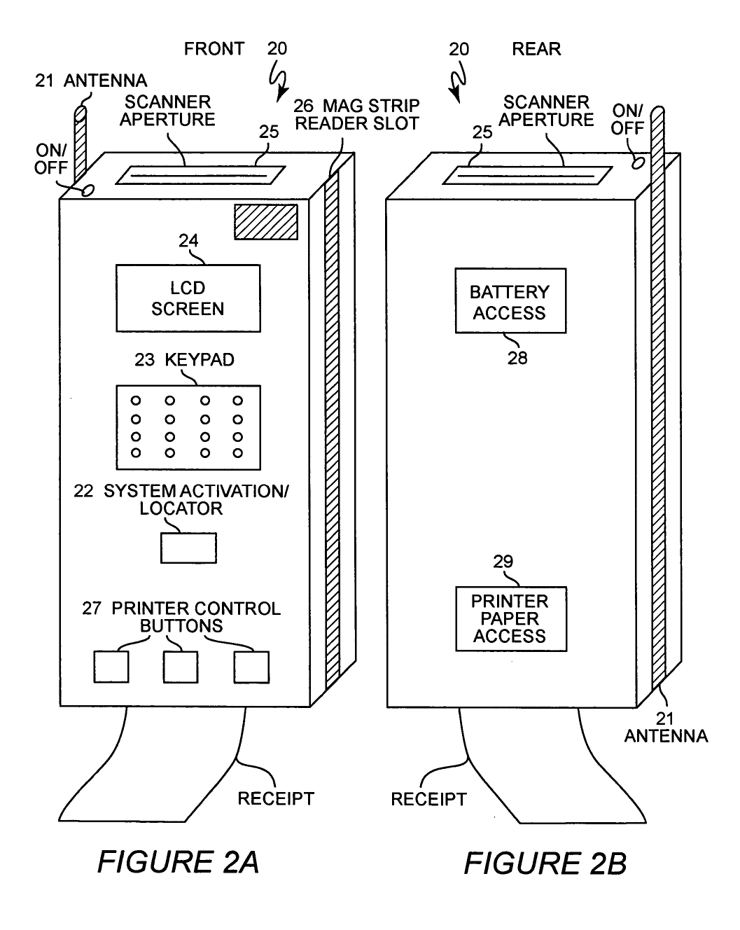

The system described thus far is conventional. The present invention provides a method and system for conducting sales transactions in a retail store environment using a virtual display of a computer system. The invention frees the customer and the sales associate from the physical restraint of needing to be at a central check out desk with computer equipment in order to complete a sale. The sales associate is equipped with an integrated activation device, bar code scanner, credit card reader, and a small receipt printer 13, shown in FIGS. 2A and 2B. This device communicates with the back office computer 10, typically by a radio frequency (RF) link using a protocol and standard, such as the Bluetooth or WiFi standards. All basic sales transactions can be handled through this method, including the ability to suspend a transaction for later completion at the check out desk 11, should this be required (particularly for cash payments).

After a sales associate discerns that a customer is finished with their shopping and is ready to complete their purchases, the sales associate signals to the system using the remote activator device. A positioning system 14 recognizes the sales associate's signal and uses a positioning algorithm to determine where and how to find an appropriate blank surface near the sales associate's actual location.

The positioning system 14 then conveys an electronic message (either through cabling or by using the in-store wireless network) to an integrated projector/camera/mirror assembly 15, which includes an application computer system that operates as a Virtual Point-of-Sale (POS) terminal. The projector assembly 15 rotates to the correct position and displays the POS application on a blank surface 16 near the location of the sales associate. The sales associate can fine-tune the positioning, size and focus by making hand signals that are read by the camera and used to move the projector assembly further.

The display on the surface 16 includes all of the buttons required to complete a transaction (e.g., numbers, transaction types and so on). Each time the sales associate wishes to make an entry, the sales associate places his or her hand over the appropriate portion of the display. The camera 15 “sees” the hand motion and interprets that motion into the appropriate computer command, just as if the sales associate was using a keyboard or touch screen on a physical computer terminal. Alternatively, the sales associate might use a pointing device, such as a light pen, to point to the appropriate places on the display.

Once correctly positioned, the sales associate would begin to use the POS application to process the customer purchase. The sales associate “enters” their system ID and Password using the virtual keyboard, to ensure that system security is maintained. A scanning device (e.g., light pen, laser scanner) can be embedded in the sales associate's activation device to allow for electronic capture of product bar codes, loyalty program membership, and so on. The sales associate would then scan merchandise bar codes, and all normal system functions would be performed (verification that the item is valid, price look up, promotional pricing, etc.) to ensure the accuracy of the data collection.

After all product data is collected and pricing is verified, the sales associate would signal to the system the preferred method of payment. In the preferred embodiment, this system would be used only to accept debit and credit card payments, since cash, checks and other payment forms usually involve franking of tenders, giving change and so on. Also, a retailer would probably not desire a sales associate to be carrying cash in an uncontrolled manner throughout the store. If the tender type is not acceptable, the transaction can be suspended and the customer can be taken to the traditional checkout desk 11 for completion of the transaction.

To complete the transaction, the sales associate would utilize the device 13, which includes a small credit card reading device, to read the customer's credit or debit card, and submit the transaction to an outside credit processor 12 for verification through the existing store network (dial up, VPN, etc.). Once accepted, the transaction would be completed by the customer, using the same virtual display to enter the customer's personal identification number (PIN), if a debit transaction, or to virtually give their signature, if a credit transaction. As a possible alternative, a PIN number will be used for both types of transactions and no signature will be required even for the credit transaction. Also, the PIN number may be entered on a keyboard incorporated into the integrated device 13.

Finally, using a small printer in the device 13, the sales associate will print a transaction receipt for the customer. Merchandise will be bagged or boxed (it is anticipated that packaging supplies will be located throughout the store for this purpose), and the customer will leave the store.

An example of the integrated activation device, scanner, magnetic stripe reader and printer carried by a sales associate is shown in FIGS. 2A and 2B. A front three quarter view is shown in FIG. 2A, while a rear three quarter view is shown in FIG. 2B. Referring first to FIG. 2A, the device 20 is provided with an antenna 21 which is used for wireless communication with the positioning system 14 (FIG. 1). The positioning system 14 would use a positioning algorithm to determine the sales associate's location. Alternatively, a position location system, which may be embedded in the floor or ceiling, can provide information to the device 20, also through the antenna 21, and this information is transmitted to the positioning system 14 when activated by the sales associate by pressing the system activation/locator button 22. The device 20 also a keypad 23 and a liquid crystal display (LCD) 24 or other suitable display. At the top of the device 20 is a scanner aperture 25 through which a bar code, for example, may be scanned. Along one side of the device 20 is a magnetic stripe reader slot 26 where a customer's credit or debit card can be slid to read the data stored in the magnetic stripe of the card. The printer is located in the bottom of the device 20 and is controlled by various printer control buttons 27 to print a receipt 28. At the rear of the device 20, as shown in FIG. 2B, are access panels 28 and 29 for battery and printer paper access, respectively.

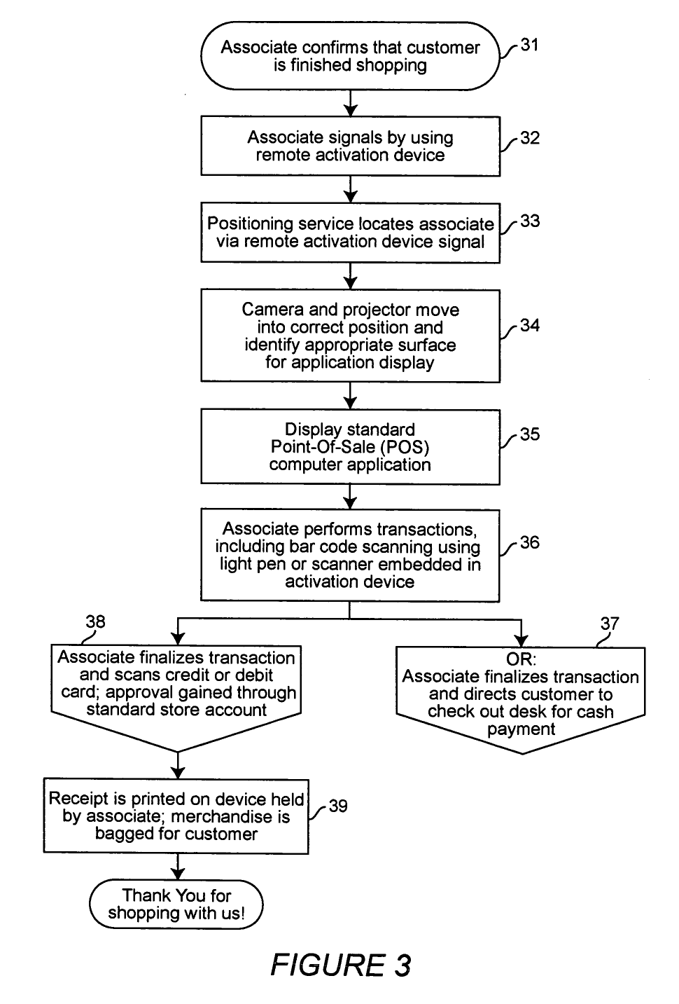

The process implemented by the system shown in FIG. 1 is illustrated in FIG. 3. The process begins in block 31 when a sales associate confirms that a customer is finished shopping. The associate signals the system in function block 32 by using his or her remote activation device. In response to the signal, a positioning application service locates the associate via the remote activation device signal in function block 33. Once the associate's location is determined, the camera and projector move into correct position and identify an appropriate surface for the Point-of-Sale application display in function block 34. The Point-of-Sale application display is projected onto the surface in function block 35. The associate performs transactions using the Point-of-Sale display in function block 36. These include bar code scanning of the merchandise and virtual keyboard entries. When the transactions are completed, a determination is made as to the method of payment. If the method of payment is cash or check, the associate finalizes the transaction and directs the customer to the checkout desk in function block 37. If the method of payment is credit or debit card, the associate finalizes the transaction and scans the credit or debit card in function block 38. Once approval of the transaction is obtained through the back office computer, a receipt is printed and the merchandise is bagged for the customer in function block 39.

The invention offers a number of advantages over traditional POS terminals in a retail environment. The virtual POS display can be displayed on any suitable surface and, therefore, does not require a fixed location in a retail store. When not being used for the virtual POS display, the projector can be used to display merchandising and sales promotions. The wireless infrastructure of the system takes the place of traditional POS hardware, allowing a greater flexibility in sales operations and store layout.

While the invention has been described in terms of a single preferred embodiment, those skilled in the art will recognize that the invention can be practiced with modification within the spirit and scope of the appended claims.

1. A virtual Point-of-Sale (POS) system for a retail store comprising:
a remote activator device carried by a sales associate;
a positioning system which recognizes a signal from the remote activator device and determines where and how to find an appropriate blank surface near the sales associate's actual location;
an integrated projector and camera assembly responsive to the positioning system and which rotates to a correct position and displays a POS application on a blank surface near the location of the sales associate, the camera detecting entries in the POS application by the sales associate as interactions with the displayed POS application;
a scanner used by the sales associate for scanning merchandise codes to enter purchases in the displayed POS application; and
a magnetic stripe reader for reading a credit or debit card to complete transaction in the displayed POS application.

2. The virtual Point-of-Sale (POS) system for a retail store recited in claim 1, wherein said remote activator device, said scanner and said magnetic stripe reader are each part of an integrated device carried by the sales associate.

3. The virtual Point-of-Sale (POS) system for a retail store recited in claim 2, wherein in the integrated device further includes a printer for printing a sales receipt.

4. The virtual Point-of-Sale (POS) system for a retail store recited in claim 1, wherein the signal from the remote activator is a wireless signal conforming to a standardized protocol.

5. The virtual Point-of-Sale (POS) system for a retail store recited in claim 1, wherein the positioning system uses a positioning algorithm to determine where and how to find a blank surface near the sales associate's actual location.

6. The virtual Point-of-Sale (POS) system for a retail store recited in claim 1, wherein the remote activator device transmits location information to the positioning system for use in determining where and how to find a blank surface near the sales associate's actual location.

7. The virtual Point-of-Sale (POS) system for a retail store recited in claim 1, further comprising a back office computer connected to receive entries in the POS application.

8. A method of operating a virtual Point-of-Sale (POS) system for a retail store comprising the steps of:
transmitting an activation signal to a positioning device;
in response to the activation signal, determining by the positioning device a source location of the activation signal;
moving by the positioning device a projector to project a virtual POS display on a surface proximate to the source location; and
detecting entries for a transaction using the virtual POS display.

9. The method of operating a virtual Point-of-Sale (POS) system for a retail store recited in claim 8, further comprising the steps of:
determining if payment is made by credit or debit card; and
if payment is made by credit or debit card, finalizing the transaction.

10. The method of operating a virtual Point-of-Sale (POS) system for a retail store recited in claim 9, wherein if a payment is not made by credit or debit card, further comprising the step of suspending the transaction for finalizing at a check out desk.
